(19) United States
(12) Patent Application Publication
(10) Pub. No.: US 2024/0021948 A1
(43) Pub. Date: Jan. 18, 2024

(54) COMPACT BATTERY MODULE UTILIZING DUAL-SIDED PCB BUS

(71) Applicant: Textron Innovations Inc., Providence, RI (US)

(72) Inventor: William A. Amante, Grapevine, TX (US)

(73) Assignee: Textron Innovations Inc., Providence, RI (US)

(21) Appl. No.: 17/812,752

(22) Filed: Jul. 15, 2022

(51) Int. Cl. H01M 50/284; H01M 10/42

(52) U.S. Cl. CPC H01M 50/284; H01M 10/425

(57) ABSTRACT

A compact battery module incorporating a dual-sided printed circuit board (PCB) bus is presented. The present disclosure provides for an increase in battery cells per given volume by utilizing both sides of a PCB bus. In one embodiment, a PCB bus can be configured to receive battery cell terminals on both sides of the PCB via one or more connectors, thereby providing for a more compact battery module that is simpler and eliminates interconnections. By having a single PCB disposed between battery cells having both the positive negative terminals on one side, a more compact design can be realized with fewer printed circuit boards and lower weight.

### TECHNICAL FIELD

The present disclosure generally relates to aircraft batteries, and more specifically to compact battery modules incorporating a dual-sided PCB bus.

### BACKGROUND

Modern aircraft rely more and more on electrical power, including hybrid aircraft and electric aircraft. Hybrid aircraft include combustible fuel and batteries to power aircraft systems. Electric aircraft require large batteries to power the aircraft's propulsion, communication, and control systems. Electric vehicles require a large volume of batteries to successfully compete in the marketplace. Conventional aircraft place the batteries in the fuselage. Although fuselage placement can provide for easy access to the batteries, such fuselage placement quickly consumes available fuselage space, decreasing the aircraft's capacity to transport cargo or personnel.

Traditional batteries require corresponding apparatus to aggregate electric potential and manage battery elements. However, such apparatus can be bulky and not customized to satisfy strict flight requirements. Usually, the larger the battery volume the larger amount of structure required to enclose and support said batteries which translates in higher weight.

### SUMMARY

The present disclosure achieves technical advantages as a compact battery module incorporating a dual-sided printed circuit board (PCB) bus. In one embodiment, the present disclosure provides for an increase in cells per given volume by utilizing both sides of a PCB bus. A PCB can be one of many different types of a battery cells bus. In one embodiment, a PCB bus can be configured to receive cell terminals on both sides of the PCB via one or more connectors, thereby providing for a more compact battery module that is simpler and eliminates interconnections. By having a single PCB disposed between battery cells having both the positive negative terminals on one side, a more compact design can be realized with fewer printed circuit boards. Other designs require two printed circuit boards—one for each side of a battery cell.

The present disclosure solves the volume problem of fitting the batteries required by an aircraft via one or more battery module configurations that are much tighter and more modular, to package more cells in a tighter space. The PCB bus can provide a positive common bus for aggregation of positive terminal voltage of battery cells disposed on each side of the PCB bus and a negative common bus for aggregation of the negative terminal voltage of battery cells disposed on each side of the PCB bus. The PCB bus can couple the battery cells of a battery module to provide a desired voltage to an aircraft or otherwise. The battery module can include any number of battery cells coupled together in series, parallel, or a combination thereof, to provide a desired voltage or battery module density.

It is an object of the disclosure to provide a dual-sided printed circuit board bus. It is a further object of the disclosure to provide a compact battery module incorporating a dual-sided PCB bus. It is a further object of the disclosure to provide a modular battery assembly. These and other objects are provided by the present disclosure, including at least the following embodiments.

In one embodiment, a dual-sided printed circuit board bus can include: a printed circuit board (PCB) having a first face and a second face; a first positive battery cell terminal connector coupled to the first face of the PCB and configured to receive a positive terminal of a first battery cell; and a second positive battery cell terminal connector coupled to the second face of the PCB and configured to receive a positive terminal of a second battery cell. Wherein the first positive battery cell terminal connector and the second positive battery cell terminal connector are electrically coupled to a positive common bus configured to receive the voltage of the first and second battery cells. Further comprising: a first negative battery cell terminal connector coupled to the first face of the PCB and configured to receive a negative terminal of the first battery cell; and a second negative battery cell terminal connector coupled to the second face of the PCB and configured to receive a negative terminal of the second battery cell. Wherein the first negative battery cell terminal connector and the second negative battery cell terminal connector are electrically coupled to a negative common bus configured to receive the voltage of the first and second battery cells. Wherein the first and second battery cells are coupled in series. Wherein the first and second battery cells are coupled in parallel. Wherein the positive common bus is operably coupled to a positive tap point. Wherein the negative common bus is operably coupled to a negative tap point. Further comprising a battery cell balancer operably coupled to the PCB and configured to maintain an equivalent state-of-charge of every cell. Further comprising a processor operably coupled to the PCB and configured to thermally manage the first or second battery cells. Wherein the first face and the second face are on opposite sides of the PCB.

In another embodiment, a compact battery module incorporating a dual-sided PCB bus can include: a printed circuit board (PCB) having a plurality of terminal connectors coupled to a first face of the PCB and a plurality of terminal connectors coupled to a second face of the PCB; a first battery brick including a plurality of battery cells having a plurality of battery cell terminals, the plurality of battery cell terminals operably coupled to at least a first portion of the plurality of terminal connectors coupled to the first face of the PCB; and a second battery brick including a plurality of battery cells having a plurality of battery cell terminals, the plurality of battery cell terminals operably coupled to at least a second portion of the plurality of terminal connectors coupled to the second face of the PCB. Further comprising insulation disposed between adjacent battery bricks. Wherein the insulation is Pyrogel® insulation. Further comprising a plurality of heat pipes disposed proximate a first side of the first battery brick and configured to thermally manage the first battery brick. Wherein the plurality of heat pipes can disperse heat from the first battery brick to cool the first battery brick or generate heat to heat the first battery brick. Further comprising a plurality of heat pipes disposed proximate a first side of the second battery brick and configured to thermally manage the second battery brick. Further comprising a coolant channel proximate the plurality of heat pipes and configured to extract heat from at least a portion of the plurality of heat pipes. Further comprising a titanium housing disposed over at least a portion of the compact battery module. Further comprising a third battery brick including a plurality of battery cells having a plurality of battery cell terminals, the plurality of battery cell terminals operably coupled to at least a third portion of the plurality of terminal connectors coupled to the first face of the PCB. Further comprising a fourth battery brick including a plurality of battery cells having a plurality of battery cell terminals, the plurality of battery cell terminals operably coupled to at least a fourth portion of the plurality of terminal connectors coupled to the second face of the PCB. Wherein the first face and the second face are on opposite sides of the PCB.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIG. 1A is a perspective view of a battery cell with leads on either end, in accordance with one or more embodiments of the present disclosure;

FIG. 1B is a perspective view of a battery cell with leads spaced horizontally on one end, in accordance with one or more embodiments of the present disclosure;

FIG. 1C is a perspective view of a battery cell with leads spaced vertically on one end, in accordance with one or more embodiments of the present disclosure;

FIG. 2A is a front view of a dual-sided battery cell bus, in accordance with one or more embodiments of the present disclosure;

FIG. 2B is a side view of a dual-sided battery cell bus, in accordance with one or more embodiments of the present disclosure;

FIG. 2C is a perspective view of a dual-sided battery cell bus, in accordance with one or more embodiments of the present disclosure;

FIG. 2D is a perspective view of a dual-sided battery cell bus with a common positive bus and a common negative bus, in accordance with one or more embodiments of the present disclosure;

FIG. 3 is a perspective view of a battery module, in accordance with one or more embodiments of the present disclosure;

FIG. 4 is a perspective view of a battery module with heat pipe walls, in accordance with one or more embodiments of the present disclosure;

FIG. 5 is a perspective view of a cable-connected battery module, in accordance with one or more embodiments of the present disclosure;

FIG. 6 is a perspective view of an aircraft battery, in accordance with one or more embodiments of the present disclosure; and

FIG. 7 is a perspective view of a battery access box, in accordance with one or more embodiments of the present disclosure.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. Pursuant to Section 904 of the Manual of Patent Examination Procedure, the Examiner, after having obtained a thorough understanding of the invention disclosed and claimed in the nonprovisional application has searched the prior art as disclosed in patents and other published documents. Therefore, as evidenced by the issuance of this patent, the prior art fails to disclose or teach the elements and limitations presented in the claims as enabled by the specification and drawings, such that the presented claims are patentable under 35 U.S.C. §§ 101, 102, 103, and 112.

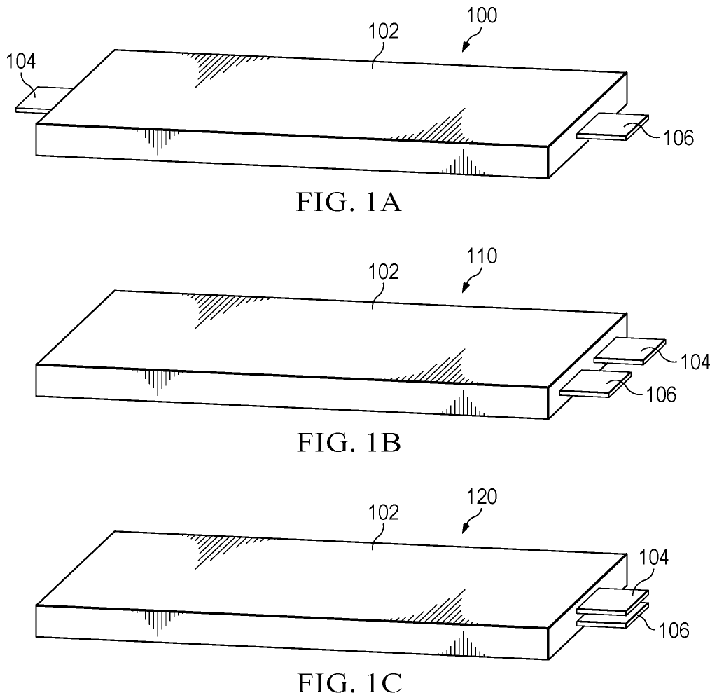

FIGS. 1A-1C show battery cells having leads in different configurations. FIG. 1A is a perspective view of a battery cell 100 with terminals (leads) disposed on either end, in accordance with one or more embodiments of the present disclosure. FIG. 1B is a perspective view of a battery cell 110 with terminals arranged horizontally on one end, in accordance with one or more embodiments of the present disclosure. FIG. 1C is a perspective view of a battery cell 120 with terminals arranged vertically on one end, in accordance with one or more embodiments of the present disclosure. In one embodiment a battery cell 100, 110, 120 can have a cell body 102, a positive lead 104, and a negative lead 106. For example, a battery cell can be a Fully Max battery cell, a GM® Ultium® battery, a Tesla® 18650, 21700, or 20700 battery, other suitable battery cell. In another embodiment, the cell body 102 can be of any type, including wet cell or dry cell, with any chemistry, including lithium ion, alkaline, or nickel metal hydride (NIMH), to name a few. In another embodiment, each battery cell 100, 110, 120 can include a positive terminal 104 and a negative terminal 106 configured to engage a load. Each terminal 104,106 can be configured to engage a battery bus to receive the battery cell voltage to suit a particular application. In one embodiment multiple battery cells 100, 110, 120 can be aggregated to form a battery module. In another embodiment, a battery can be comprised of two or more battery modules.

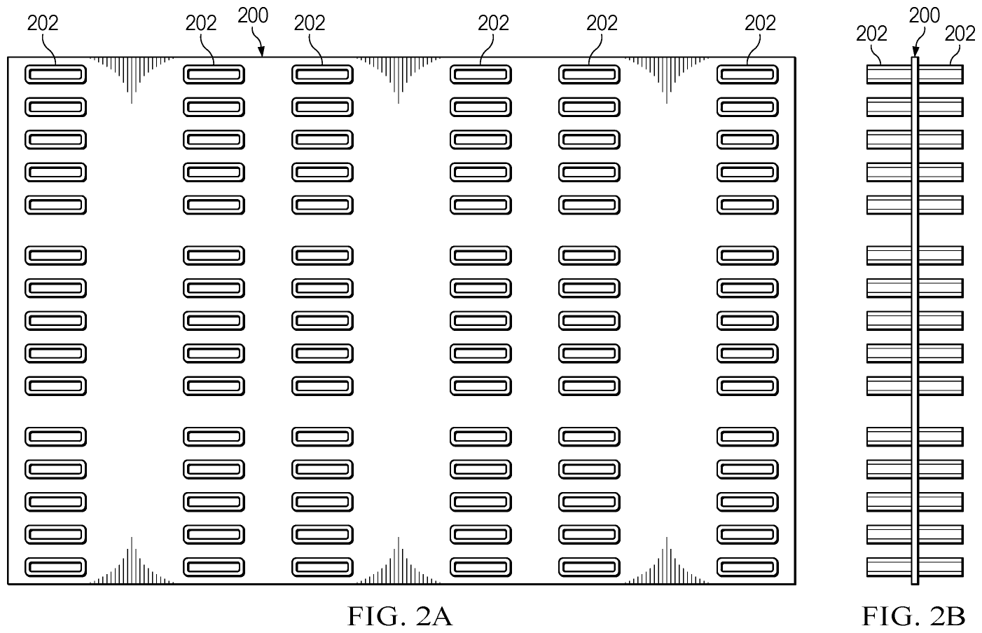

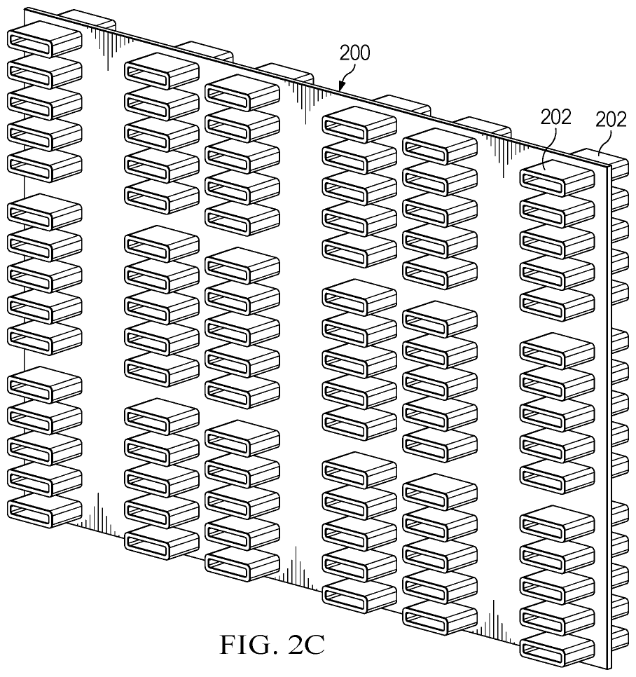

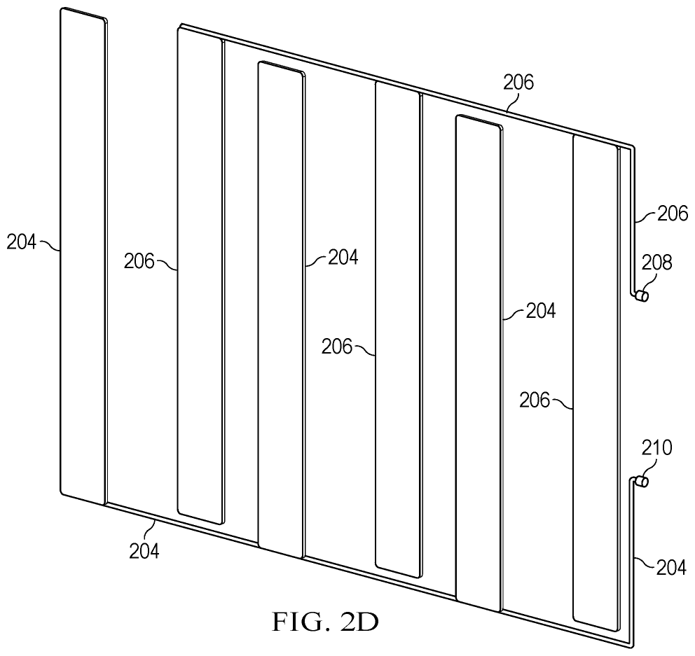

FIGS. 2A-2D show different views of a dual-sided battery cell bus 200, in accordance with one or more embodiments of the present disclosure. FIG. 2A is a front view of a dual-sided battery cell bus, in accordance with one or more embodiments of the present disclosure. In one embodiment, the dual sided battery cell bus 200 can include a plurality a battery cell terminal connectors 202 disposed on a first face of the dual-sided battery cell bus 200. In another embodiment, the dual sided battery cell bus 200 can include a plurality of battery cell terminal connectors 202 disposed on a second face of the dual-sided battery cell bus 200. The battery cell terminal connectors 202 can be shaped and sized to receive it battery terminal of a battery cell. The battery cell terminal connectors 202 can be spaced to accommodate a positive terminal lead and a negative terminal lead disposed on one end of a battery cell. The vertical distance between the battery cell terminal connectors 202 can be adjusted such that the battery cells can be stacked and still engage the battery cell terminal connectors 202 of the dual-sided battery cell bus 200. The battery cell terminal connectors 202 can be grouped on the dual-sided battery cell bus 200 to accommodate a battery cell brick. For example, a battery cell brick can include five battery cells. In another embodiment, adjacent battery cell terminal connectors 202 can alternate to receive positive battery cell leads and negative battery cell leads.

FIG. 2B is a side view of a dual-sided battery cell bus, in accordance with one or more embodiments of the present disclosure. In one embodiment, the battery cell terminal connector is 202 of the first face of the dual sided battery cell bus 200 and the second face of the dual sided battery cell bus 200 can align. In another embodiment, the battery cell terminal connector 202 of the first face of the dual sided battery cell bus 200 and the second face of the dual sided battery cell bus 200 can be offset. For example, by offsetting the battery cell terminal connectors 202 on both sides of the dual sided battery cell bus 200, the condition of each battery cell can be sensed and controlled. In another embodiment, can be coupled to the PCB to both electrically connect and mechanically fasten them to it.

FIG. 2C is a perspective view of a dual-sided battery cell bus, in accordance with one or more embodiments of the present disclosure. In one embodiment, a printed circuit board (PCB) can be a structure having conductive and insulating layers. For example, the PCB can provide reliable electrical connections (and reliable open circuits) between the component's terminals in a controlled manner. In another embodiment, the conductive layers can be designed with a pattern of conductors that provide electrical connections on that conductive layer. In another embodiment, vias (e.g., plated-through holes that allow interconnections between layers) can be disposed within a PCB. In one embodiment, a battery management system (BMS) can have a battery cell balancer and/or a processor. In another embodiment, the BMS can be disposed on the PCB. In another embodiment, battery modules can have a BMS, and the whole battery can have a battery management unit (BMU), with connections to the aircraft. A BMS can be present at the module level (or cell level), and a BMU at the battery level. In another embodiment, two battery cells can be coupled to the PCB bus 200, one on each side (face), to create a single tap point for both battery cells. In another embodiment, to manage each cell individually, two battery cells can be coupled to the PCB in an offset arrangement, one on each side, to create a tap point for each battery cell. The tap point can be controlled by the BMS to control each battery cell or battery cell pair. For example, the processor can connect or disconnect each battery cell or battery cell pair from the PCB bus 200 via the tap point associated with each battery cell or battery cell pair.

The individual cells in a battery pack can have different capacities or health levels, so, over the course of charge and discharge cycles, can be at different states of charge (SOC). Variations in capacity can be due to manufacturing variances, assembly variances (e.g., cells from one production run mixed with others), cell aging, impurities, or environmental exposure (e.g., some cells may be subject to additional heat from nearby sources like motors, electronics, etc.), and can be exacerbated by the cumulative effect of parasitic loads, such as the cell monitoring circuitry often found in a BMS.

Balancing a multi-cell pack helps to maximize capacity and service life of the pack by working to maintain equivalent state-of-charge of every cell, to the degree possible given their different capacities, over the widest possible range. In one embodiment, a full BMS might include active balancing as well as temperature monitoring, charging, and other features to maximize the life of a battery pack. In another embodiment, battery balancing can be performed by DC-DC converters, in one of the topologies: Cell-to-battery; Battery-to-cell; and Bidirectional. Cell balancers and processors can be added on each side of the PCB. Battery cell terminal arrangement on each side of bus will depend on if cell is in series or in parallel. There can be a combination of both, some in parallel and some in series. Or there can be an offset so they are not connected.

FIG. 2D is a perspective view of a common positive bus and a common negative bus for a dual-sided battery cell bus, in accordance with one or more embodiments of the present disclosure. In one embodiment, the dual sided battery cell bus 200 can include a negative common bus 204 disposed within the PCB. For example, the battery cell terminal connector 202 can be electrically coupled to the negative common bus 204. In another embodiment, the negative common bus 204 can be disposed within the dual sided battery cell bus 200 and electrically coupled to a plurality of battery cell terminal connectors 202 configured to receive a negative battery terminal. In another embodiment, the dual sided battery cell bus 200 can include a positive common bus 206 disposed within the PCB. In another embodiment, the positive common bus 206 can be disposed within the dual sided battery cell bus 200 and electrically coupled to a plurality of battery cell terminal connectors 202 configured to receive a positive battery terminal.

PCBs can include conductive pads in a shape designed to accept the component's terminals. For example, the conductive pads can electrically couple the terminals using traces, planes and other features etched from one or more sheet layers of copper laminated onto and/or between sheet layers of a non-conductive substrate, among other architectures. In another embodiment, the negative common bus 204 can be shaped and positioned to be electrically coupled to the plurality of battery cell terminal connectors 202 configured to receive a negative battery cell terminal. In another embodiment, the positive common bus 204 can be shaped and positioned to be electrically coupled to the plurality of battery cell terminal connectors 202 configured to receive a positive battery cell terminal. for example, the negative common bus 204 can be positioned to be electrically coupled to alternating columns of battery cell terminal connectors 202, and the positive common bus 206 can be positioned to be electrically coupled to alternating columns of battery cell terminal connectors 202. In another embodiment, the negative common bus 204 and the positive common bus 206 can be electrically coupled to battery cell terminal connectors 202 on the first face of the dual sided battery cell bus 200 as well as battery cell terminal connectors 202 disposed on the second face of the dual sided battery cell bus 200.

In another embodiment, the negative common bus 204 can receive voltages from the negative terminals of battery cells connected to battery cell terminal connectors 202 on the first face of the dual sided battery cell bus 200, as well as voltages from the negative terminals of battery cells connected to battery cell terminal connectors 202 on the second face of the dual sided battery cell bus 200. in another embodiment, the battery cells opera blee coupled to the battery cell terminal connectors 202 disposed on a first face of the dual sided battery cell bus 200 can have a first orientation, while the battery cells operably coupled to the battery cell terminal connectors 202 disposed on the second face of the dual-sided battery cell bus 200 can have a second orientation, such that the battery cell negative terminals are aligned and electrically coupled to the negative common bus 204. For example, when the battery cell terminal connectors 202 are aligned on both faces of the dual-sided battery cell bus 200, one battery cell can be flipped such that the cell terminals on either side of the dual-sided battery cell bus 200 have the same polarity.

In another embodiment, a PCB can have vias routed to one or more common busses disposed within or on the PCB bus 200 (e.g., the positive common bus 206 and the negative common bus 204). The negative common bus 204 and the positive common bus 206 can be electrically separated within or on the PCB bus 200. In another embodiment, the positive common bus 206 can be accessible by a positive access point 208 disposed on the dual sided battery cell bus. In another embodiment, the negative common bus 204 can be accessible by a negative access point 210 disposed on the dual sided battery cell bus. For example, the positive access point 208 and the negative access point 210 can include electrical connectors. In another embodiment, the positive access point 208 and the negative access point 210 can be disposed on one end of the PCB for aggregation with other similar positive access points 208 and the negative access points 210 from other battery modules or coupling with a BMS.

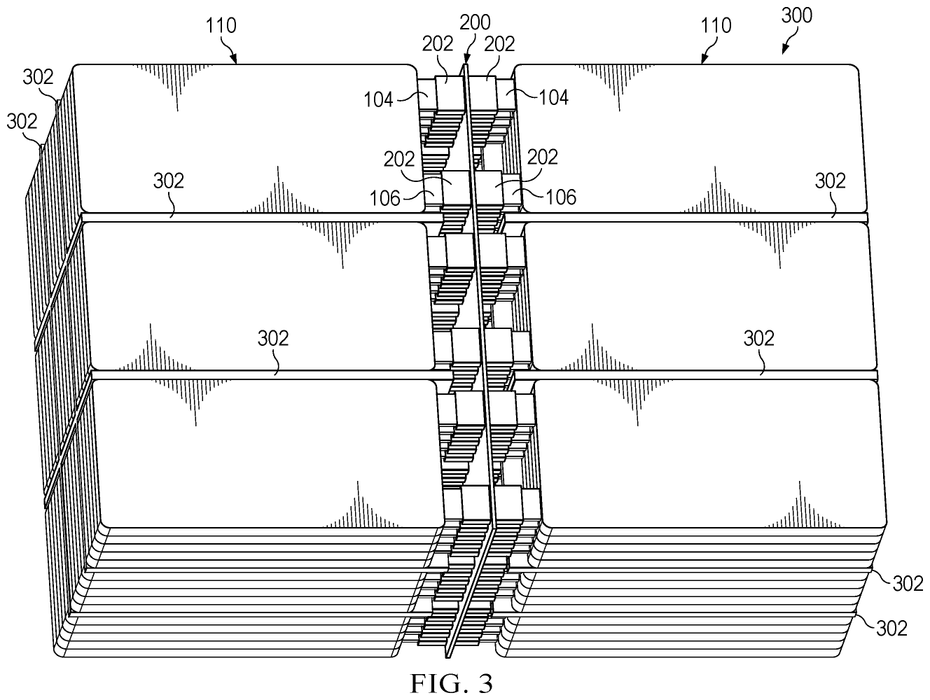

FIG. 3 is a perspective view of a battery module 300, in accordance with one or more embodiments of the present disclosure. In one embodiment, a battery cell 110 with battery cell terminals 104, 106 arranged horizontally on one end can be electrically coupled with a dual sided battery cell bus 202 by inserting the first (e.g., negative) battery cell terminal 104 and the second (e.g., positive) battery cell terminal 106 into respective battery cell terminal connectors 202. In another embodiment, a set of five cells can be referred to as a battery cell brick or simply, a brick. In another embodiment, insulation 302 (e.g., Pyrogel®) can be disposed (e.g., vertically, horizontally, or both) between the bricks of a battery module to thermally isolate the bricks for improved thermal runaway control. For example, with battery cells operably coupled to opposing sides (faces) of the PCB bus 200, a brick can be thermally insulated from an adjacent brick so if there is a thermal runaway, the insulation 302 can prevent or mitigate the thermal runaway from propagating to adjacent bricks or cells.

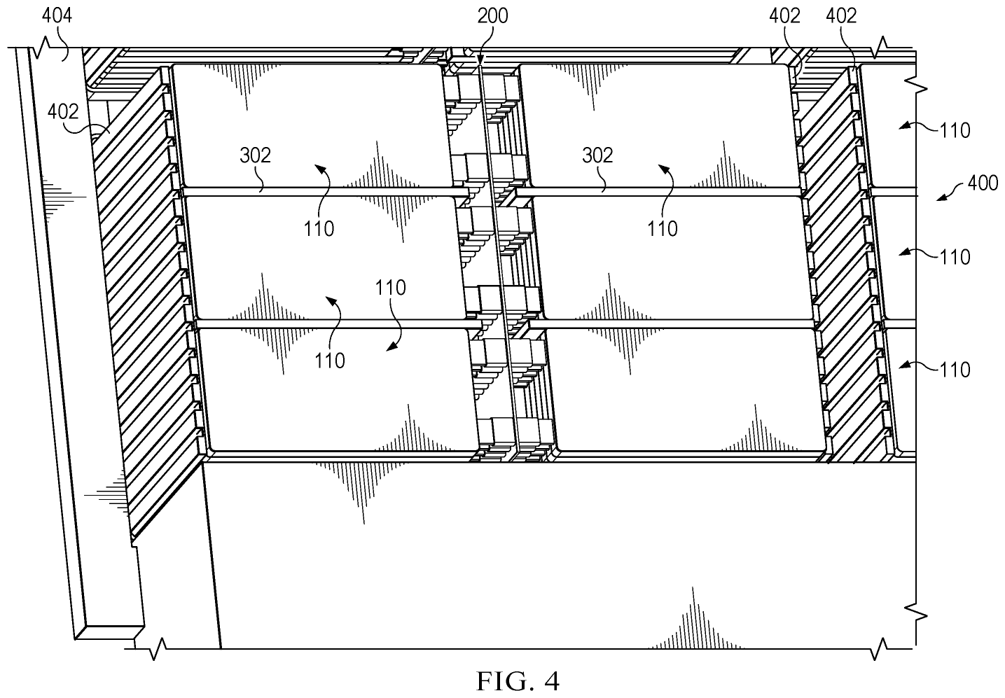

FIG. 4 is a perspective view of a battery module 400 with heat pipes 402, in accordance with one or more embodiments of the present disclosure. In one embodiment, a battery module 400 can include a plurality of a battery cells 110 with battery cell terminals arranged horizontally on one end electrically coupled to the PCB bus 200. In another embodiment, a plurality of heat pipes arranged in a heat pipe wall 402 can be disposed proximate the battery cells 110 to add thermal management of the battery cells 110. For example, a set of heat pipes on the cell ends can pull heat away or introduce heat to the battery cells 110, if desired. In another embodiment, the heat pipes can be operably coupled to coolant channels 404 to produce a cooling effect. For example, running coolant into battery modules can cause electrical system problems if there is a leak. However, a microchannel coolant system can be employed to provide additional cooling functionality when needed. The heat pipes 402 can be much more reliable as there is no fluid to leak. In another embodiment, the heat pipes 402 can be operably coupled to a heating element to produce heat. Coupling the heat pipes 402 with the coolant channel 404, and the insulation 302 can provide effective thermal management of the battery module 400.

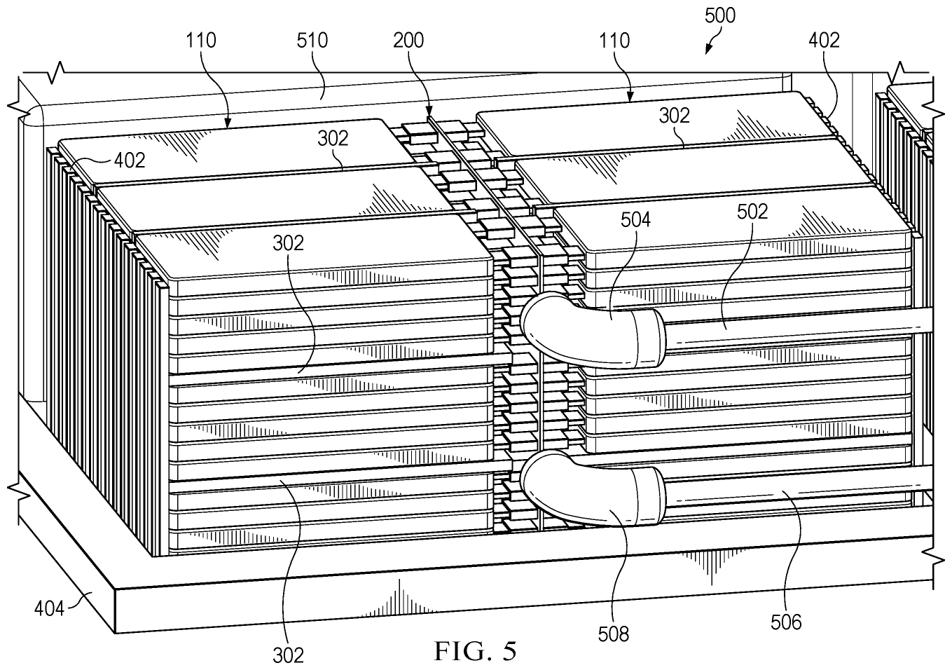

FIG. 5 is a perspective view of a cable-connected battery module 500, in accordance with one or more embodiments of the present disclosure. In one embodiment, a plurality of battery cells 110 can be operatively coupled to opposing faces of a battery cell bus 200. In another embodiment, the battery module 500 can include thermal management systems such as heat pipe wall 402, insulation 302, and coolant channel 404. In another example, a positive battery wire 502 can be operatively coupled to the positive access point 208 disposed on the dual sided battery cell bus 200 via a positive wire connector 504. In another example, a negative battery wire 506 can be operatively coupled to the negative access point 210 disposed on the dual sided battery cell bus 200 via a negative wire connector 508. For example, the positive wire connector 504 and the negative wire connector 508 can be bayonet connectors, coaxial connectors, or other suitable connector. In another embodiment, positive battery wire 502 can aggregate the positive access point 208 with other positive access points from one or more other battery modules or couple the positive access point 208 with a BMS. In another embodiment, negative battery wire 506 can aggregate the negative access point 210 with other negative access points from one or more other battery modules or couple the negative access point 210 with a BMS. In another embodiment, the battery module 500 can be disposed within at least a portion of a titanium cover 510.

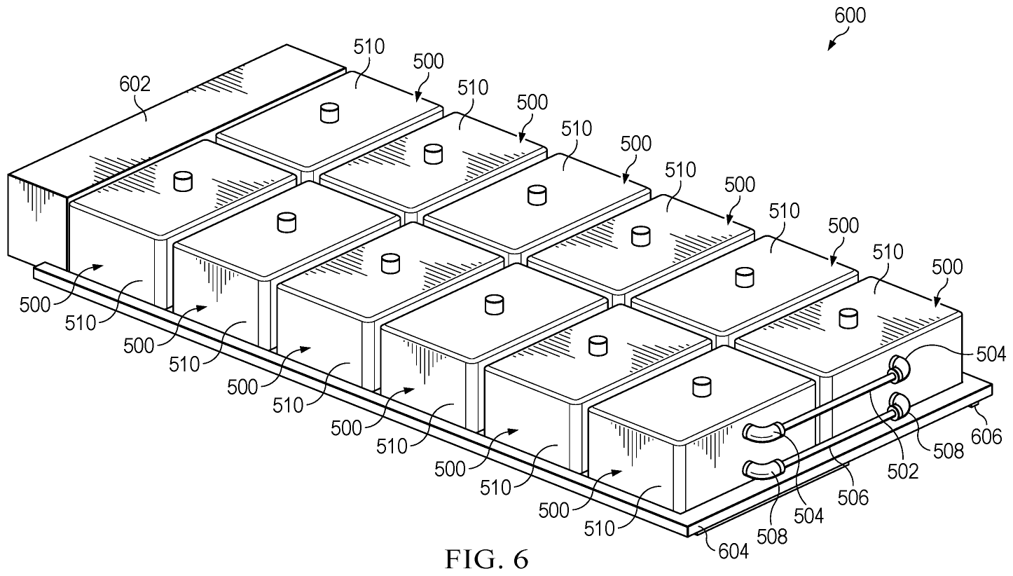

FIG. 6 is a perspective view of an aircraft battery 600, in accordance with one or more embodiments of the present disclosure. In one embodiment, a 12-battery module configuration can provide sufficient voltage to power an aircraft. For example, with 12 battery modules, the battery cell 110 proximity can be modular, such that if there is a thermal runaway, since the battery module is smaller than the entire battery, it can be contained, thereby mitigating the chances of thermal runaway propagating to the rest of battery. In another embodiment, a titanium housing 510 can protects the thermal runaway of one battery module 500 from another battery module 500 within the same battery 600. For example, the titanium housing 510 can be a sheet metal, for example O20-thick. With temperatures rising to 1500 to 2000 degrees Celsius, or more, titanium can be well suited to handle such temperatures without melting at about half the weight of steel. In another embodiment, positive battery wires 502 can aggregate the positive access points 208 of the battery modules 500 or couple a positive access point 208 with a battery management unit (BMU) 602. In another embodiment, negative battery wires 506 can aggregate the negative access points 210 of the battery modules 500 or couple a negative access point 210 with a BMU 602. In another embodiment, the battery 600 and all of its components can be disposed on a battery module shelf 604. For example, the battery module shelf 604 can have one or more adjustable feet 606 to orient the battery 600.

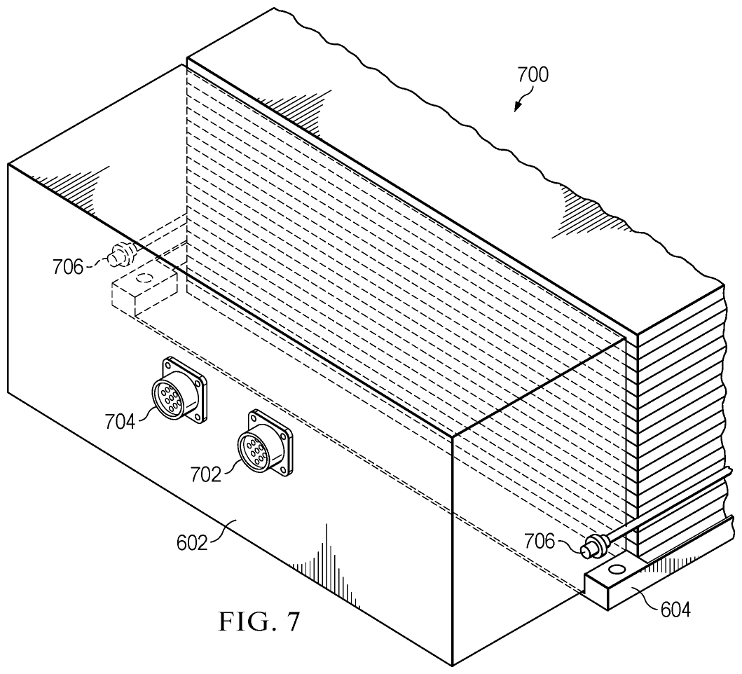

FIG. 7 is a perspective view of a battery access box, in accordance with one or more embodiments of the present disclosure. In one embodiment, the BMU 602 can control the thermal management systems such as the heat pipe wall 402 and coolant channel 404, as well as the BMSs associated with each battery module. The BMU 602 can also provide access to the power supplied by the battery 600 via one or more electrical connectors (e.g., a positive electrical connector 702 and a negative electrical connector 704). In another embodiment, the microchannel coolant system can also be supplied with coolant via one or more microchannel coolant connectors 706. In another embodiment, the battery module shelf can support at least a portion of the BMU 602.

Persons skilled in the art will readily understand that advantages and objectives described above would not be possible without the particular combination of PCB hardware and other structural components and mechanisms assembled in this inventive system and described herein. The description in this patent document should not be read to imply that any particular element, step, or function is an essential or critical element that must be included in the claim scope.

None of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. The scope of the claims can include one, some, or portions of any of the embodiments disclosed herein, either alone or in combination. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A dual-sided printed circuit board bus, comprising:
a printed circuit board (PCB) having a first face and a second face;
a first positive battery cell terminal connector coupled to the first face of the PCB and configured to receive a positive terminal of a first battery cell; and
a second positive battery cell terminal connector coupled to the second face of the PCB and configured to receive a positive terminal of a second battery cell.

2. The PCB bus of claim 1, wherein the first positive battery cell terminal connector and the second positive battery cell terminal connector are electrically coupled to a positive common bus configured to receive the voltage of the first and second battery cells.

3. The PCB bus of claim 1, further comprising:
a first negative battery cell terminal connector coupled to the first face of the PCB and configured to receive a negative terminal of the first battery cell; and
a second negative battery cell terminal connector coupled to the second face of the PCB and configured to receive a negative terminal of the second battery cell.

4. The PCB bus of claim 3, wherein the first negative battery cell terminal connector and the second negative battery cell terminal connector are electrically coupled to a negative common bus configured to receive the voltage of the first and second battery cells.

5. The PCB bus of claim 1, wherein the first and second battery cells are coupled in series.

6. The PCB bus of claim 1, wherein the first and second battery cells are coupled in parallel.

7. The PCB bus of claim 3, wherein the positive common bus is operably coupled to a positive tap point.

8. The PCB bus of claim 4, wherein the negative common bus is operably coupled to a negative tap point.

9. The PCB bus of claim 1, further comprising a battery cell balancer operably coupled to the PCB and configured to maintain an equivalent state-of-charge of every cell.

10. The PCB bus of claim 1, further comprising a processor operably coupled to the PCB and configured to thermally manage the first or second battery cells.

11. A compact battery module incorporating a dual-sided PCB bus, comprising:
a printed circuit board (PCB) having a plurality of terminal connectors coupled to a first face of the PCB and a plurality of terminal connectors coupled to a second face of the PCB;
a first battery brick including a plurality of battery cells having a plurality of battery cell terminals, the plurality of battery cell terminals operably coupled to at least a first portion of the plurality of terminal connectors coupled to the first face of the PCB; and
a second battery brick including a plurality of battery cells having a plurality of battery cell terminals, the plurality of battery cell terminals operably coupled to at least a second portion of the plurality of terminal connectors coupled to the second face of the PCB.

12. The compact battery module of claim 11, further comprising insulation disposed between adjacent battery bricks.

13. The compact battery module of claim 12, wherein the insulation is Pyrogel® insulation.

14. The compact battery module of claim 11, further comprising a plurality of heat pipes disposed proximate a first side of the first battery brick and configured to thermally manage the first battery brick.

15. The compact battery module of claim 14, wherein the plurality of heat pipes can disperse heat from the first battery brick to cool the first battery brick or generate heat to heat the first battery brick.

16. The compact battery module of claim 14, further comprising a plurality of heat pipes disposed proximate a first side of the second battery brick and configured to thermally manage the second battery brick.

17. The compact battery module of claim 14, further comprising a coolant channel proximate the plurality of heat pipes and configured to extract heat from at least a portion of the plurality of heat pipes.

18. The compact battery module of claim 11, further comprising a titanium housing disposed over at least a portion of the compact battery module.

19. The compact battery module of claim 11, further comprising a third battery brick including a plurality of battery cells having a plurality of battery cell terminals, the plurality of battery cell terminals operably coupled to at least a third portion of the plurality of terminal connectors coupled to the first face of the PCB.

20. The compact battery module of claim 11, further comprising a fourth battery brick including a plurality of battery cells having a plurality of battery cell terminals, the plurality of battery cell terminals operably coupled to at least a fourth portion of the plurality of terminal connectors coupled to the second face of the PCB.
